(19) United States
(12) Patent Application Publication
(10) Pub. No.: US 2016/0073106 A1
(43) Pub. Date: Mar. 10, 2016

(54) TECHNIQUES FOR ADAPTIVE VIDEO STREAMING

(71) Applicant: Apple Inc., Cupertino, CA (US)

(72) Inventors: Yeping Su, Sunnyvale, CA (US); Hsi-Jung Wu, San Jose, CA (US); Ke Zhang, San Jose, CA (US); Chris Y. Chung, Sunnyvale, CA (US); Xiaosong Zhou, Campbell, CA (US)

(21) Appl. No.: 14/703,366

(22) Filed: May 4, 2015

Related U.S. Application Data
(60) Provisional application No. 62/047,415, filed on Sep. 8, 2014.

(51) Int. Cl. H04N 19/10

(52) U.S. Cl. CPC H04N 19/10

(57) ABSTRACT

In a video coding system, a common video sequence is coded multiple times to yield respective instances of coded video data. Each instance may be coded according to a set coding parameters derived from a target bit rate of a respective tier of service. Each tier may be coded according to a constraint that limits a maximum coding rate of the tier to be less than a target bit rate of another predetermined tier of service. Having been coded according to the constraint facilitates dynamic switching among tiers by a requesting client device processing resources or communication bandwidth changes. Improved coding systems to switch among different coding streams may increase quality of video streamed while minimizing transmission and storage size of such content.

### CROSS-REFERENCE TO RELATED APPLICATION

The present application benefits from priority of U.S. application Ser. No. 62/047,415, filed Sep. 8, 2014, the contents of which are incorporated herein in their entirety.

### BACKGROUND

In the scenario of adaptive streaming, a common video sequence often is coded to multiple streams at different bitrates. Each stream is often partitioned to a sequence of transmission units (called “chunks”) for delivery. A manifest file often is created that identifies the bit rates available for the video sequence. In a streaming service, for example, video streams and accompanied playlist files are hosted in a server. A player in a client device that gets stream information by accessing the playlist files, which allows it to switch among different streams according to estimates of available bandwidth. However, current coding systems do not efficiently accommodate switches among different coding streams representing a common video content item.

The inventors perceive that switching problems are likely to be common at points where an instantaneous data rate of a coded video sequence exceeds a target bit rate at which the coded video sequence was coded. Consider, for example, a video sequence that is coded for a target bit rate of 1 Mbps. A video coder will derive a set of coding parameters for coding that are predicted to yield coded video data at or near the target bit rate, for example 0.9 Mbps, based on estimates of the video sequence's complexity and content. The video sequence's content, however, may deviate from the video coder's estimates, perhaps in short term situations, that would cause the coded data rate to exceed the target bit rate substantially. For example, if coded data rate may jump to 1.5 Mbps, which could exceed resource limits of a client device's session. The client device likely will attempt to switch to another copy of the coded video data that was developed for a lower target bit rate but the other copy also may exceed the client device's resource limits, at least for the short term event that causes a rise in the instantaneous data rate. A client device may have to iteratively identify and request different copies of the coded video until it settles on a copy having a data rate that meets its resource limitations. As it does so, the client device may experience an interruption in rendered video which can reduces perceived quality of the decoding session.

Accordingly, the inventors have identified a need in the art for video streaming techniques that provide efficient switching among different coded streams of a common video sequence.

### BRIEF DESCRIPTION OF THE DRAWINGS

FIG. 1 is a simplified block diagram of a video distribution system suitable for use with the present disclosure.

FIG. 2 is a simplified block diagram of a system having an integrated coding server and distribution server according to an embodiment of the present disclosure.

FIG. 3 illustrates a method 300 according to an embodiment of the present disclosure.

FIG. 4 illustrates a bit rate graph of tier encoding according to an embodiment of the present disclosure.

FIG. 5 illustrates a coding method according to another embodiment of the present disclosure.

FIG. 6 illustrates exemplary coded video streams according to an embodiment of the present disclosure.

FIG. 7 illustrates application of tiers to code video streams according to an embodiment of the present disclosure.

### DETAILED DESCRIPTION

Embodiments of the present disclosure provide techniques for coding video data in which a common video sequence is coded multiple times to yield respective instances of coded video data. Each instance may be coded according to a set coding parameters derived from a target bit rate of a respective tier of service. Each tier may be coded according to a constraint that limits a maximum coding rate of the tier to be less than a target bit rate of another predetermined tier of service. Having been coded according to the constraint facilitates dynamic switching among tiers by a requesting client device processing resources or communication bandwidth changes. Improved coding systems to switch among different coding streams may increase quality of video streamed while minimizing transmission and storage size of such content.

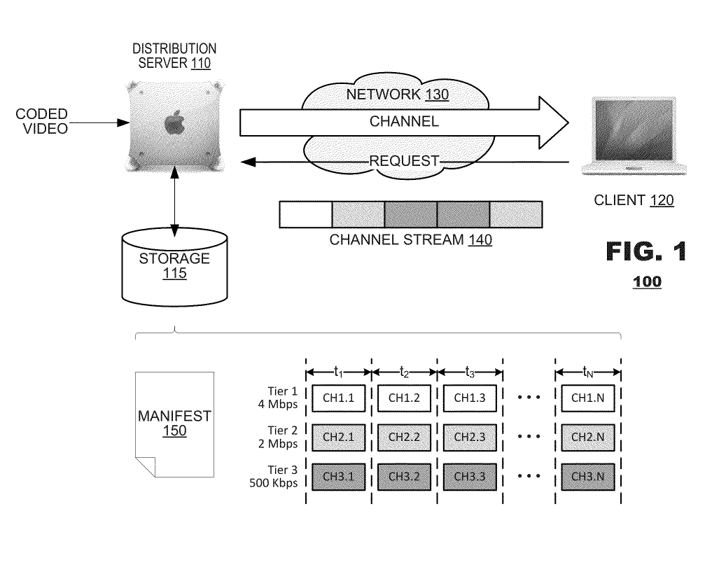

FIG. 1 is a simplified block diagram of a video distribution system 100 suitable for use with the present disclosure. The system 100 may include a distribution server system 110 and a client device 120 connected via a communication network 130. The distribution system 100 may provide coded video data to the client 120 in response to client requests. The client 120 may decode the coded video data and render it on a display.

The distribution server 110 may include a storage system 140 on which are stored a variety of video content items 150 (e.g., movies, television shows and other motion picture content) for download by the client device 120. A single video content item 150 is illustrated in the example of FIG. 1. The distribution server 110 may store several coded representations 152-156 of the video content item 150, shown as “tiers,” which have been coded with different coding parameters. The tiers 152-156 may vary by average bit rate, which may be induced by differences in coding—e.g., coding complexity, frame rates, frame size and the like. Each video stream tier 152, 154, 156 may be parsed into a plurality of “chunks” CH1.1-CH1.N, CH2.1-CH2.N and CH3.1-CH3.N, coded segments of the video content item 150 representing the video content at different times. The different chunks may be retrieved from storage and delivered the client 120 over a channel defined in the network 130. The aggregation of transmitted chunks represents a channel stream 160 in FIG. 1.

The example of FIG. 1 illustrates three coded video tiers Tier 1, Tier 2, and Tier 3, each coded into N chunks (1 to N) at different average bit rates. In the example of FIG. 1, the tiers 152, 154, 156 are coded at 4 Mb/s, 2Mb/s and 500 Kb/s respectively. In this example, the chunks of each tier are temporally aligned so that chunk boundaries define respective durations (t₁, t₂, t₃, . . . , t_{N}) of video content. Other embodiments may not temporally align chunk boundaries, however, and they may provide a greater or lesser number of tiers than are shown in FIG. 1.

The distribution server 110 also may store an index file 158, called a “manifest file” herein, that describes the video content item 150 and the different tiers 152-156 that are available for each tier. The manifest file 158 may associate the coded video streams with the video content item 150 and correlate chunks of each coded video stream with corresponding chunks of the other video streams. The manifest file 158, for example, may provide metadata that describes each tier of service, which the client 120 may reference to determine which tier of service to request. The manifest file 158 also may identify storage locations of each chunk on the storage system 140 for retrieval by the client device 120.

When the distribution server 110 receives a request for a video content item 150, the server 110 may provide data from the manifest file 158 to the client device 120. Armed with information representing different data rates of the coded video streams, the client device 120 may identify one of the video streams (say, tier 152) or one of the average bit rates for delivery of video. The device's identification of delivery bandwidth may be based on an estimate of bandwidth available in the network 130 and/or an estimate of processing resources available at the client device 120 to decode received data. In response, the distribution server 110 may retrieve chunks of data from storage 140 at the specified data rate, may build a channel stream 160 from the retrieved chunks and may transmit the channel stream 160 to the client device 120.

Over time, as the distribution server 110 delivers its chunks to the client device 120, the client device 120 may request delivery of the video content item 150 at a different data rate. For example, the client device 120 may revise its estimates of network bandwidth and/or local processing resources. In response, the distribution server 110 may retrieve chunks corresponding to a different data rate (say, tier 154) and build them into the channel stream 160. The client device 120 may request different data rates repeatedly during a delivery session and, therefore, a channel stream 160 that is delivered to the client device 120 may include chunks taken from a variety of the video coding streams.

For a live streaming situation, the client device 120 may be requesting “live content” from the distribution server 110, e.g. content that is being produced as the source and being encoded and distributed as soon as possible. In this situation, the encoder may change video stream settings during the live streaming session, and the initial information in the manifest file 158 may be updated by the distribution server 110 during live streaming.

The manifest file 158 may include syntactic elements representing various parameters of the coded media item that the client 120 may reference during a decode session. For example, it may include, for each tier, an indication of whether it contains chunks with different resolutions. The client device 120 may decide whether it should update video resolution information at the beginning of chunks.

In another embodiment, the manifest file 158 may include, for each tier, an indication of whether the first frames of all the chunks are synchronization frames. The client device 120 may decide which frame or chunk to switch to when switching among tiers.

In another embodiment, the manifest file 158 may include, for each tier, an indication of its visual quality. The client device may switch among tiers to achieve the best visual experience, for example, maximizing average visual quality and/or minimizing visual quality jumps.

In another embodiment, the manifest file 158 may include, for each chunk, an indication of its average bit rate. The client device may determine its buffering and switching behavior according to the chunk average bit rates.

In another embodiment, the manifest file 158 may include, for each chunk, an indication of its resolution. The client device may decide whether it should update video resolution.

In another embodiment, the manifest file 158 may include, for each tier, an indication of the required bandwidth to play the rest of the stream starting from or after a specific chunk. The client device may decide which tier to switch to.

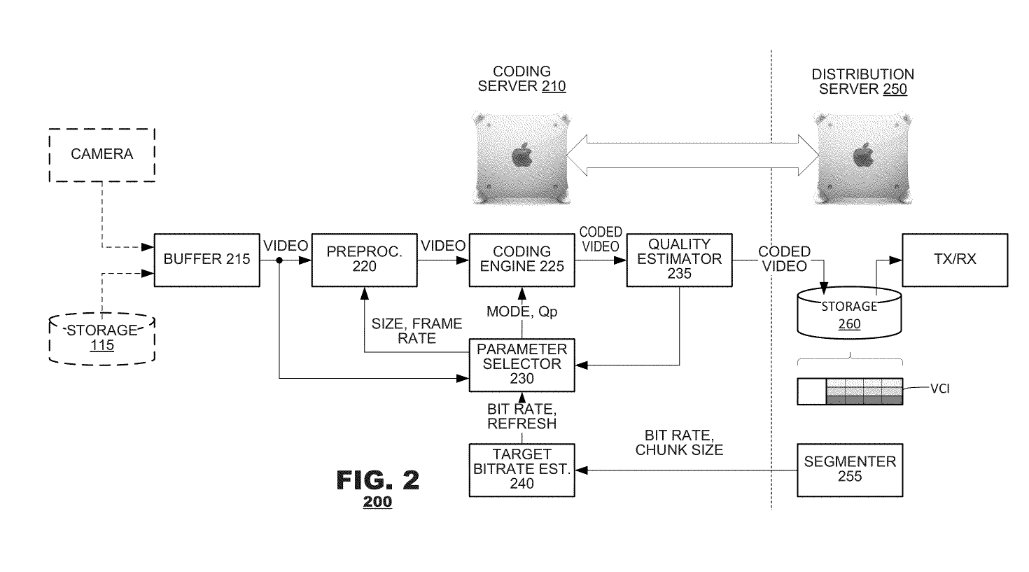

FIG. 2 is a simplified block diagram of a system 200 having an integrated coding server 210 and distribution server 250. The content server 210 may include a buffer storage device 215, a preprocessor 220, a coding engine 225, a parameter selector 230, a quality estimator 235, and a target bit-rate estimator 240. The buffer storage 215 may store input video, typically from a camera or a storage device. The preprocessor 220 may apply processing operations to the video, typically to condition the video for coding or to alter perceptual elements in the video. The coding engine 225 may apply data compression operations to the video sequence input by the preprocessor 220 that may reduce its data rate. The parameter selector 230 may generate parameter data to the preprocessor 220 and/or coding engine 225 to govern their operation. The quality estimator 235 may estimate quality of coded video data output by the coding engine 225. The target bit-rate estimator 240 may generate average bit-rate estimates for chunks of video based on the data rates and chunk sizes to be supported by the distribution server 250, which may be identified to the bit-rate estimator 240 by the distribution server 250.

The preprocessor 220 may apply processing operations to the video, typically to condition the video for coding or to alter perceptual elements in the video. For example, the preprocessor 220 may alter a size and/or a frame rate of the video sequence. The preprocessor 220 may estimate spatial and/or temporal complexity of input video content. The preprocessor 220 may include appropriate storage so that size and/or frame rate modifications may be performed repeatedly on a common video sequence as the coding server 210 generates its various coded versions of the sequence.

A coding engine 225 may apply data compression operations to the video sequence input by the preprocessor 220. The coding engine 225 may operate according to any of the common video coding protocols including the MPEG, H.263, H.264, and HEVC families of coding standards. The coding engine 225 may apply coding parameters to different elements of the video sequence, including, for example:
Coding mode selection: Whether to code an input frame as an I-frame, P-frame or B-frame, whether block-level mode to code a given image block.
Quantization parameters: Which quantization parameter levels to apply within frame as coded video data.

A parameter selector 230 may generate parameter data to the preprocessor 220 and/or coding engine 225 to govern their operation. The parameter selector 230, for example, may cause the preprocessor 220 to alter the size and/or frame rate of data output to the coding engine 225. The parameter selector 230 may impose coding modes and/or quantization parameters to the coding engine 225. The parameter selector 230 may select the coding parameters based on average bit rate estimates received from the target bit-rate estimator 240 and based on complexity estimates of the source video.

A quality estimator 235 may estimate quality of coded video data output by the coding engine. The quality estimator 235 may output digital data representing a quantitative estimate of the quality of the coded video data.

A target bit-rate estimator 240 may generate average bit-rate estimates for chunks of video based on the data rates to be supported by the distribution server 250.

During operation, the target bit-rate estimator 240 may apportion an average bit rate to the video sequence and determine a refresh rate based on data rate and chunk size estimates provided by the distribution server 250. In response to the average bit rate selected by the target bit-rate estimator 240 and based on analysis of the video sequence itself, the parameter selector 230 may select operational parameters for the preprocessor 220 and/or coding engine 225. For example, the parameter selector 230 may cause the preprocessor 220 to adjust the frame size (or resolution) of the video sequence. The parameter selector 230 also may select coding modes and quantization parameters to frames within the video sequence. The coding engine 225 may process the input video by motion compensation predictive techniques and output coded video data representing the input video sequence.

The quality estimator 235 may evaluate the coded video data and estimate the quality of the video sequence coded according to the selected parameters. The quality estimator 235 may determine whether the quality of the coding meets predetermined qualitative thresholds associated with the average bit rate set by the distribution server 250. If the quality estimator 235 determines that the coding meets the thresholds, the quality estimator 235 may validate the coding. By contrast, if the quality estimator 235 determines that the coding does not meet sufficient quality thresholds associated with target average bit rate, the quality estimator 235 may revise the coding parameters applied by the parameter selector 230 and may cause the preprocessor 220 and coding engine 225 to repeat operation on the source video.

Once the parameter selector 230 selects a set of processing and coding parameters that satisfy quality metrics established by the quality estimator 235, the coding server 210 may advance to the next average bit rate supported by the distribution server 250. Again, the parameter selector 230 and quality estimator 235 may operate recursively, selecting parameters, applying them in preprocessing operations and coding, estimating quality of the coded video data obtained thereby and revising parameters until the quality requirements are met.

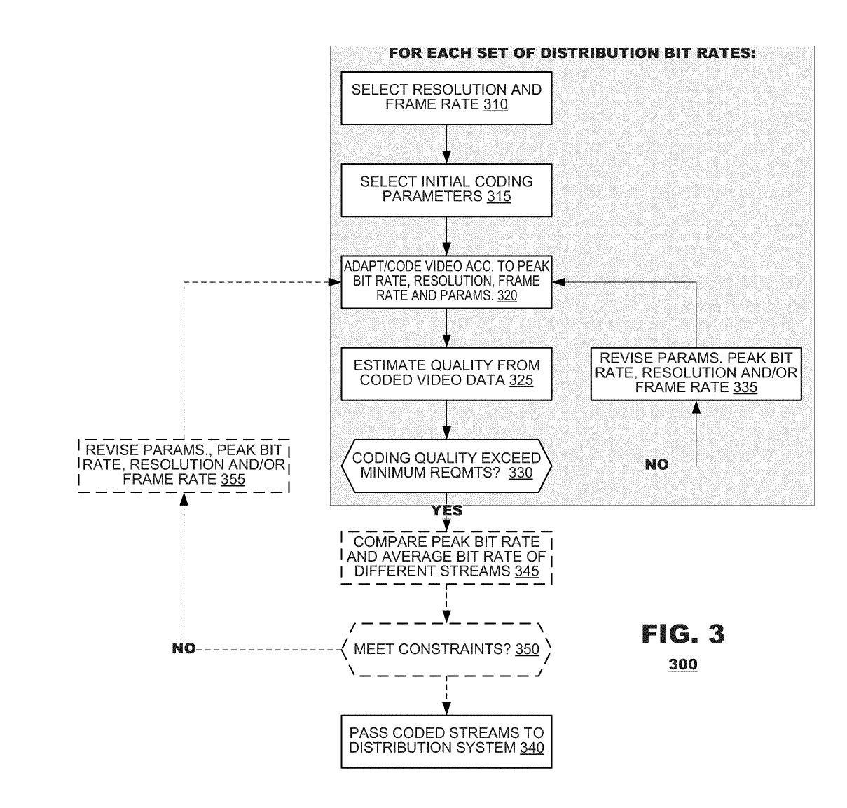

FIG. 3 illustrates a method 300 according to an embodiment of the present disclosure. The method 300 may process a source video sequence iteratively using each tier of distribution average bit rates as a governing parameter. During each iteration, the method 300 may select a resolution and/or frame rate of the video sequence (box 310). The resolution and frame rate may be derived from the average bit rates of the tiers available to the distribution server 250 (FIG. 2).

The method 300 also may select an initial set of coding parameters for processing of the video (box 315). The initial parameters also may be derived from the distribution average bit rates supported by the distribution server 250. The method 300 may cause the video to conform to the selected peak bit rate, resolution and frame rate and may have the video sequence coded according to the selected parameters (box. 320). Thereafter, the method 300 may estimate the quality of video data to be recovered from the coded video sequence obtained thereby (box 325) and may determine whether the coding quality exceeds the minimum requirements (box 330) for each tier with the specified distribution average bit rate. If not, the method 300 may revise selections of peak bit rate, resolution, frame rate and/or coding parameters (box 335) and may cause operation to return to box 320. In an embodiment, the method 300 may pass the coded streams to the distribution system (box 340).

In another embodiment, the method 300 may iteratively increment the peak bit rate of each chunk during encoding such that the quality of each chunk meets the minimum quality requirement of the tier (box 335), but the peak bit rate of each chunk is minimized.

In another embodiment, the method 300 may set a limit on the peak bit rate of each tier, based upon the specified distribution average bit rate of each tier, and enforcing the limit during revising of the coding parameters (box 335). This may be done, for example, by setting a peak bit rate to average bit rate ratio (PtA) for each tier. The higher average bit rate tiers may be set with lower PtA than the lower average bit rate tiers, because encoding quality may be sufficiently good at higher average bit rate tiers without significantly higher peak bit rate, and lower peak bit rate would mean less bandwidth consumption for streaming of the video.

In another embodiment, when coded video is obtained that meets the minimum quality requirements for all streams, the method 300 may compare peak bit rates and average bit rates of the obtained tiers against each other based upon some constraints (box 345). The method 300 may determine whether the peak bit rates and average bit rates of the obtained tiers meet the constraints (box 350). If so, then the method 300 may pass the coded streams to the distribution system (box 340). If not, however, then the method 300 may revise peak bit rate, resolution, frame rate and/or coding parameter selections of one or more of the coded video sequences that exhibit insufficient qualitative differences with other streams (box 350) and may cause the operation of boxes 320-335 to be repeated upon those streams (box 355). Operation of this embodiment of method 300 may repeat until the video sequence has been coded under all distribution average bit rates and sufficient qualitative differences have been established for the sequence at each coded rate.

In another embodiment, the constraints may be defined as a maximum difference between the average bit rate of a higher average bit rate tier and the peak bit rate of a lower average bit rate tier. For example, a constraint may be defined as “peak bit rate of tier (X+2) is no larger than average bit rate of tier X.” The constraints may be defined based upon channel switching schemes in the client device receiving the streams, to prevent unnecessarily large or unnecessarily frequent inter-tier switching. Assuming the client device switches to a higher bit rate tier if the higher bit rate tier's average bit rate may be accommodated in the transmission bandwidth and switches to a lower bit rate tier that has a peak bit rate that may be accommodated in the transmission bandwidth.

The method 300 accommodates several variations. In one embodiment, the encoder may determine video resolutions, video frame rates and average bit rates jointly based upon the characteristics of visual quality and streaming performance. Optionally, the encoder may control target average bit rates by considering visual quality variations among streams with similar bit-rate values. Alternatively, the encoder may control the video resolution and frame rate at a specific average bit rate based upon a quality measurement of the coded video such as the peak signal-to-noise ratio (PSNR) or a perceptual quality metric.

In other embodiments, the encoder may vary the duration of coded chunks. For example, the encoder may adapt the duration of chunks according to the local and global bit-rate characteristics of coded video data. Alternatively, the encoder may adapt the duration of chunks according to the local and global visual-quality characteristics of the coded video data. Optionally, the encoder may adapt the duration of chunks in response to detections of scene changes within the source video content. Or, the encoder may adjust the duration of chunks based upon video coder requirements for addition of synchronization frames of the coded streams.

In further embodiments, the encoder may adjust the frame rate of video. For example, the encoder may adjust the frame rate at a chunk level, i.e., chunks of a single stream and chunks of multiple streams corresponding to the same period of source video. Alternatively, the encoder may adjust the frame rate of video iteratively, at a chunk level, in multiple passes of the coding engine. In a multi-pass encoder embodiment, the encoder may decide how to place chunk boundaries and which chunks will be re-encoded in future passes based on the collected information of average bit rates and visual quality from previous coding passes.

An encoder may optimize the frame rate and chunk partitioning by reducing the peak chunk bit rate. A dynamic programming approach may be applied to determine the optimal partition by minimizing the peak chunk bit rate. Alternatively, an encoder may optimize the frame rate and chunk partitioning by reducing the overall variation of chunk bit rates. A dynamic programming approach may be applied to determine the optimal partition by minimizing the variation of chunk bit rates. Further, the encoder may optimize the frame rate and chunk partitioning to guarantee particular constraints of visual quality, measured by metrics such as PSNR of the coded video.

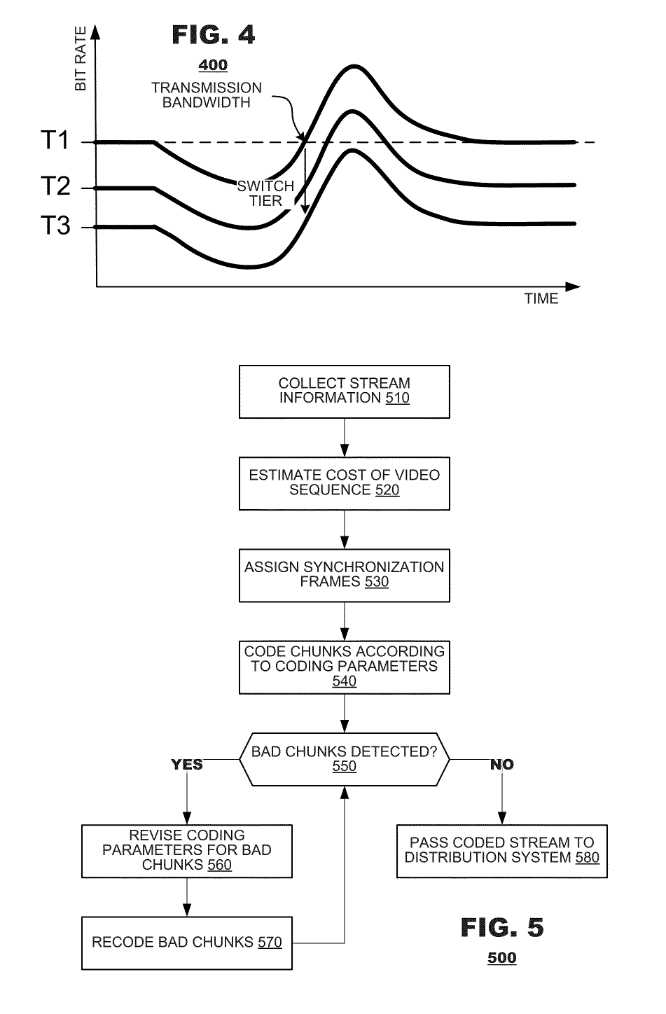

FIG. 4 illustrates a bit rate graph of tier encoding according to an embodiment of the present disclosure. According to an embodiment, during encoding, the encoder may constrain the tiers such that tier T3's peak bit rate is lower than the average bit rate of tier T1. During playback, if the client device encounters a peak section with bit rate that cannot be accommodated in the transmission bandwidth, the client device may switch to a lower bit rate tier from tier T1.

In an embodiment, the method 300 in FIG. 3 may set parameters for the tiers (box 335) to configure the encoder to adjust for scaling of tier storage aspect ratio to appropriate display resolution. This may be done, for example, by setting a pixel aspect ratio (PAR) for each tier.

Since tiers could have different frame storage resolutions in encoding, the display aspect ratio may not match after upscaling in decoding.

Some tier storage resolutions may be chosen with the same aspect ratio as the source video (such as for full 1080p content). Consider the following example tiers.

TABLE 1

| TIER | WIDTH | HEIGHT | STORAGE ASPECT RATIO |
|---|---|---|---|
| T1 | 1920 | 1080 | 16:9 |
| T2 | 1280 | 720 | 16:9 |
| T3 | 864 | 486 | 16:9 |
| T4 | 736 | 414 | 16:9 |

Without cropping, all tiers above have the same aspect ratio of 16:9.

However, if a cropping parameter is applied for wide screen content, this approach may not work. For example, if the source is cropped to 1920×936 pixel resolution, then some lower resolution tiers using the same width resolutions may result with non-integer height pixel resolutions with the same aspect ratio.

TABLE 2

| TIER | WIDTH | HEIGHT | STORAGE ASPECT RATIO |
|---|---|---|---|
| T1 | 1920 | 936 | 80:39 |
| T2 | 1280 | 624 | 80:39 |
| T3 | 864 | 421.2 | 80:39 |
| T4 | 736 | 358.8 | 80:39 |

During encoding, the height may be rounded to the nearest even integer (due to the 4:2:0 format) and the lower tiers no longer have the same aspect ratio as the source.

TABLE 3

| TIER | WIDTH | HEIGHT | STORAGE ASPECT RATIO |
|---|---|---|---|
| T3 | 864 | 422 | 432:211 |
| T4 | 736 | 358 | 368:179 |

When they are scaled up in the client device to the full size for displaying, the scaled up display heights become 938 pixels for T3 and 934 pixels for T4, instead of 936 pixels of the source. This much difference in resolution from the source may be visible and may negatively affect the viewing experience. This may be solved by applying appropriate PAR as below.

Pixel aspect ratio (PAR)=Display aspect ratio (DAR)/Storage aspect ratio (SAR)

The PAR for the example above would be:

TABLE 4

| TIER | PIXEL ASPECT RATIO |
|---|---|
| T3 | 1055:1053 |
| T4 | 895:897 |

The method 300 may accommodate several other variations. For example, the encoder may encode SAR/PAR as variables within a tier, e.g. one set of SAR/PAR/DAR defined per video chunk. Alternatively, the encoder may compute PARs for all tiers based on the top tier's DAR and define the PARs in the video streams; a client device may use the PARs received in the video streams to rescale for displaying.

In another embodiment, PAR and/or DAR information may be sent to client device in a manifest file 158. A client device may determine a single uniform display resolution for all the chunks associated with the manifest file 158 using the information, and then scale all tiers to that display resolution.

In a further embodiment, the client device may determine an appropriate PAR or display resolution on the fly, e.g. calculating the display resolution based on the DAR information for the highest tier in the manifest tile or in playback history. The client device then may scale all tiers to that resolution without additional info in the video streams.

This technique may also be applied to cases where tier storage resolutions are decided by other reasons, e.g. where the tier storage resolution is a multiple of 16 due to the size of a macroblock (or 64 for a macroblock in HEVC encoding) for better coding efficiency.

In other embodiments, the PAR may be content adaptive. For example, when the source video (chunk/scene) is in high motion, the tier storage resolution may be reduced in encoding by applying a PAR. Elsewhere, when the source video (chunk/scene) has less variations or high motion in a specific dimension (for example the horizontal dimension), the tier storage resolution dimension may be reduced in encoding by applying a PAR in the specific dimension. Alternatively, when the source video (chunk/scene) has objects of interest (e.g. text), a less aggressive PAR may be applied to keep the tier storage resolution higher.

FIG. 5 illustrates a coding method 500 according to another embodiment of the present disclosure. The method 500 may cause an input video sequence to be coded according to a distribution average bit rate. The method 500 may begin by collecting information of the video sequence to be coded (box 510), for example, by performing a pre-encoding pass on the source to estimate spatial complexity of frame content, motion of frame content, and the like based on motion-compensated residual and/or objective quality measures. The method 500 may estimate costs (for example, encoding processing time, encoding buffer size, storage size at the distribution server, transmission bandwidth, decoding processing time, decoding buffer size, etc.) for various portions of the video sequence from the statistics and assign preprocessing and coding parameters to those portions (box 520). The method 500 also may assign certain frames in the video sequence to be synchronization frames within the coded video sequence to coincide with chunk boundaries according to delivery parameters that govern at the distribution server (box 530). Thereafter, the method 500 may code the source video according to coding constraints estimated from the coding cost and according to chunk boundaries provided by the distribution server (box 540). Once the source video is coded, the method 500 may identify badly coded chunks (box 550), i.e., chunks that have coded quality that fail required norms or chunks that have data rates that exceed predetermined limits. The method 500 may revise coding parameters of the bad chunks (box 560), recode the bad chunks (box 570) and detects bad chunks again (box 550). Once all chunks have been coded in a manner that satisfies the coding quality requirements and governing data rates, the method 500 may pass the coded stream to the distribution system (box 580).

In an embodiment, after the method 500 recodes bad chunks to yield coded chunks, the method 500 may recode data chunk(s) for video data to smooth coding quality of the video sequence.

The method 500 accommodates several variations. For example, an encoder may determine the tier storage resolutions by considering tier bit rate, frames per second, quality change between neighboring tiers, and video characteristics. The encoder may select the tier storage resolutions by limiting quality difference between neighboring tiers. The encoder may select lower storage resolutions for higher frame per second source, e.g. maintaining similar number of encoding pixels/second. Alternatively the encoder may select higher storage resolutions for easy-to-encode portions of video sources, based upon the complexity of video sources, e.g. based on motion-compensated residual and/or objective quality measure, estimated by the pre-encoding pass performed on the video sources.

For example, advanced encoding techniques, such as more reference frames and advanced motion estimation, may be applied to lower tiers and/or harder to code sections. Advanced encoding standards, e.g. HEVC, may be applied to lower tiers and/or harder-to-code sections. If decoding hardware/buffer are not limited in a client device, more advanced encoding standards may be selected for lower tiers and/or harder to code sections. This may reduce the bandwidth size of the video chunks in transmission, which may improve video streaming. If decoding hardware/buffer is limited in the client device, less advanced encoding standards may be selected for lower tiers and/or harder to code sections. This may reduce the computing and buffering requirement in the client device.

In an embodiment, an encoder may adapt pre-processing, e.g. with stronger denoising/smoothing filter for harder to code sections.

An encoder also may perform rate-control to anticipate efficient buffering of data in the client device. For example, an encoder may define certain buffer constraints to facilitate streaming. In this example, the duration of continuously high bit rate section and/or number of high bit rate sections may be limited to reduce/avoid switching to lower tiers. Alternatively, an encoder may code lower bit rate sections before a hard-to-encode section to avoid switching to lower tiers or aid switching to higher tiers by freeing up some bandwidth.

In other embodiments, an encoder may design video streams by considering startup time in playback or previewing, with specific optimizations for the chunks in the beginning of video streams, as well as other chunks of interests such as chapters. An encoder may use more limited peak bit rate for the beginning portions, such that the beginning portions may be easier and faster to decode for playback or previewing. An encoder may apply advanced encoding tools/pre-processing techniques to reduce the bit rate. An encoder also may apply quality-driven bit rate optimizations to minimize bit rate while guarantee a quality threshold.

In a further embodiment, an encoder may jointly produce video streams by sharing encoding information across tiers, such as frame types, e.g. guarantee sync frames aligned across tiers to help client device reduce switching overhead. An encoder may jointly produce video streams by sharing QP and bits distribution. Multiple tiers may share the information to speed up encoding process, e.g. use N+1 encoding passes to produce N tiers, compared with traditional N+2 pass encodings. An encoder also may jointly produce video streams by sharing encoding information of macroblocks (MB), e.g. mode decision, motion vectors, reference frame index and etc. For multiple resolution tiers, the information may be spatially mapped to account for the scaling factor. For example, when upscaling to a higher resolution, one MB at low resolution tier may cover/overlap multiple MBs of a high resolution tier and therefore the decoding of the overlapping MBs may utilize the encoding information of all the overlapping MBs.

A preprocessor's output, preprocessed/denoised source video, may be shared as an input for coding of multiple tiers. Similarly, a preprocessor's analysis of source video characteristics, e.g. detection of banding-prone regions, motion strength calculation, and/or texture strength calculation, may be shared for multiple tiers.

An encoder may produce video quality meta data indicating the quality of encoding. The encoder may measure video quality to account for source/display resolution/physical display size. For example, low tier encoded data may be upscaled and compared at source resolution relative to higher tiers at the same section of the video streams. The encoder may use quality meta data to measure playback quality, e.g. quality change at switching points, average quality of playback chunks.

Quality metadata may be accessed by the client device at runtime to assist buffering/switching. For example, if quality of a currently-decoded tier is sufficient, a client device may switch to higher tiers conservatively to avoid likelihood of switching to lower tiers at some point in future. A client device may identify future low quality chunks and pre-buffer their corresponding high tier chunks before they are required for decode; such an embodiment may preserve coding quality over a video decoding session.

The quality meta data of encoded tiers also may be used for:
Tier decision/selection. For example, tiers may be selected to meet a constraint of maximum quality difference between neighboring tiers.
Initial tier selection. For example, in the beginning of playback, the client device may select a tier with acceptable quality value.
Selection of coding parameters for a top tier. For example, to save data/bandwidth for cellular connection, top tier may be limited to the tier with a high enough quality value.
Interaction between download and streaming. For example, if a streaming tier has similar quality as download encode but at lower bit rate, it may be used for download to save bandwidth.

The method 500 may further accommodate other variations. For example, a single stream could contain chunks with different resolutions and frame rates. One single chunk could contain frames with different resolutions and frame rates. The resolution and frame rate may be controlled based on the average bit rate of chunks. The resolution and frame rate may be controlled based on the visual quality of the chunks coded at different resolutions.

The resolution and frame rate may be controlled by a scene change of the source video.

In another embodiment, a mixed resolution stream could be produced in multi-pass encoding. For example, a video coder may detect video sections with low visual quality, suggested by quantization factor, PSNR value, statistical motion and texture information. The detected low-quality sections then may be re-encoded at an alternative resolution and frame rate, which produces better visual quality.

In a further embodiment, a mixed resolution stream may be produced with a post composition method. For example, at similar average bit rates, the source video may be coded at multiple resolutions and frame rates. The produced streams may be partitioned into chunks. The chunks then may be selected to form a mixed-resolution stream.

The chunk selection described hereinabove may be controlled to maintain visual quality across the coded sequence measured by quantization factor, PSNR value, and statistical motion and texture information. Moreover, the chunk selection described hereinabove may be controlled to reduce changes of visual quality, resolution, and frame rate across the coded sequence. When producing a mixed resolution stream, the encoder may control the temporal positions of resolution switching and frame-rate switching to align with scene changes.

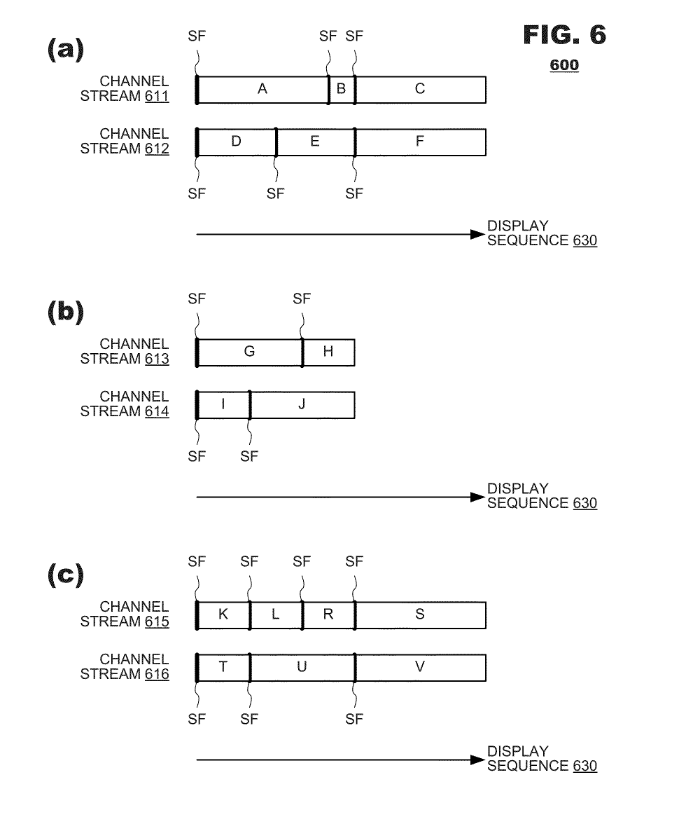

FIGS. 6(a)-6(c) illustrate application of synchronization frames (SF) to coded video streams according to an embodiment of the present disclosure. According to the present disclosure, an encoder (in FIG. 2) may encode the first frame of each chunk may be coded as a synchronization frame SF that may be decoded without reference to any previously-coded frame of the video sequence. The synchronization frame may be coded as an intra-coded frame (colloquially, an “I frame”). For example, if the video sequence is coded according to the H.264 coding protocol, the synchronization frame may be coded as an Instantaneous Decoder Refresh frame (“IDR frame”). Other coding protocols may provide other definitions of I frames. An encoder's encode decision on IDR positions may have influence on segmentation result, and may be used to improve streaming quality.

As illustrated in FIG. 6(a), channel stream 611 may encoded as chunks A, B, and C with durations of 5 seconds, 1 second, and 5 seconds respectively, based on a maximum chunk size constraint of 5 seconds. However, the tail ends of chunks A and C may involve quality decline that are noticeable. Additionally, because SF's tend to take more bits to encode, the bit rate around chunk B may be higher than the other portions. According to embodiments of the present disclosure, an encoder (in FIG. 2) may encode chunks D, E, and F with durations of 3 seconds, 3 seconds, and 5 seconds respectively (channel stream 612), based on a minimum chunk size constraint of 3 seconds. Because the chunks D, E, and F are much more even in channel stream 612, the bit rate may be smoothed out and quality may be improved.

As illustrated in FIG. 6(b), channel stream 613 may encoded as chunks G and H with durations of 4 seconds and 2 seconds respectively, based on the relative complexity and difficulty of encoding for each portion. Chunk G may contain a portion of content that is relatively easy to encode, and chunk H may contain a portion of content that is relatively difficult to encode. Having a longer chunk G for an easier to encode portion than chunk H may allow chunk G and chunk H to have similar storage size. However, the harder to encode chunk H may have higher peak and average bit rates, which may potentially cause difficulties in transmission to the client device. According to embodiments of the present disclosure, an encoder (in FIG. 2) may encode chunks I and J with durations of 2 seconds and 4 seconds respectively (channel stream 614), based on the relative complexity and difficulty of encoding for each portion. Here, channel stream 614 may encode a longer chunk for the harder to encode portion in chunk J. This allows chunk J to shift its SF forward toward the easier to encode portion of chunk I. The longer chunk J also allows chunk J to smooth out its bit rate over long duration, thus avoiding high peak and high average bit rates, without sacrificing quality of video.

As illustrated in FIG. 6(c), channel stream 615 may encoded as chunks K, L, R, and S with durations of 2 seconds, 2 seconds, 2 seconds, and 5 seconds respectively, based on a minimum chunk size of 2 seconds. However, if chunk R includes a relatively harder to encode portion, then the harder to encode chunk R may have higher peak and average bit rates, which may potentially cause difficulties in transmission to the client device. According to embodiments of the present disclosure, an encoder (in FIG. 2) may encode chunks T, U, and V with durations of 2 seconds, 4 seconds, and 5 seconds respectively (channel stream 616), based on the relative complexity and difficulty of encoding for each portion. Here, the channel stream 616 effectively encodes the portions of chunks L and R from channel stream 615 into 1 single chunk U, thus encoding a longer chunk for the harder to encode portion in chunk R. This allows chunk U to shift its SF forward toward the easier to encode portion of chunk T. The longer chunk U also allows chunk U to smooth out its bit rate over long duration, thus avoiding high peak and high average bit rates, without sacrificing quality of video.

The application of the encoder and the segmenter may further determine optimal chunk boundaries by optimizing one or more of the following objectives:
Maximizing the minimum chunk lengths in the video stream.
Minimizing the variation of chunk lengths in the video stream.
Minimizing the peak chunk bit rate in the video stream.
Minimizing the variation of chunk bit rate in the video stream.

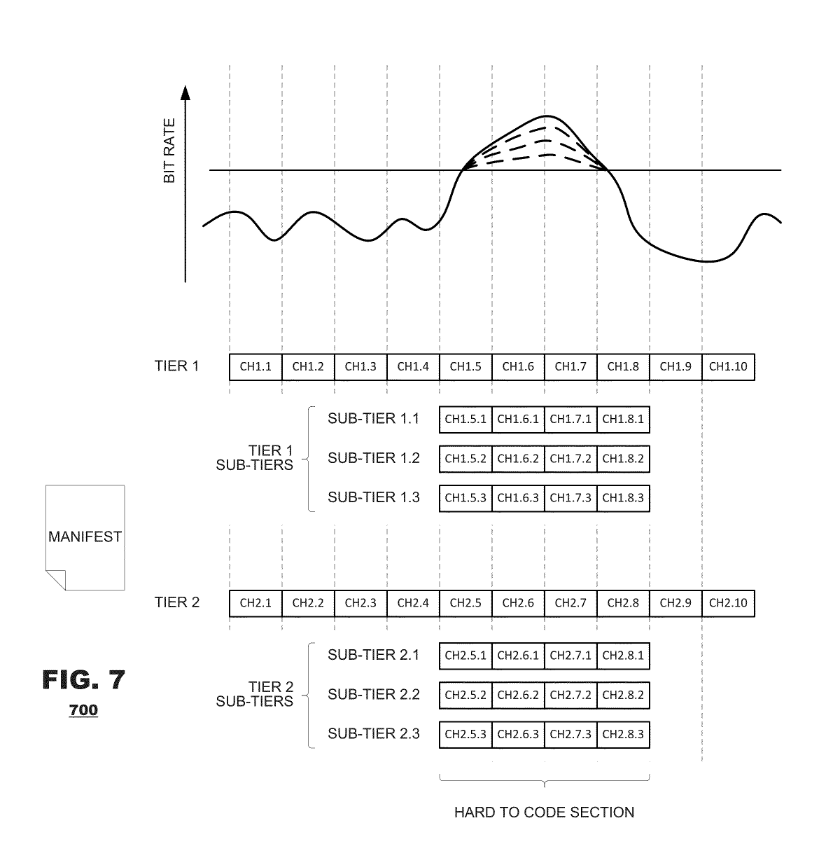

FIG. 7 illustrates application of additional tiers to code video streams according to an embodiment of the present disclosure. According to the present disclosure, an encoder (in FIG. 2) may encode a video content initially with 2 tiers (Tier 1 and Tier 2) with respective chunks (CH1.1-CH1.10 and CH2.1-CH2.10). The encoder may measure the bit rate of the chunks in at least one of the tiers. For example, bit rate curve 710 may represent the bit rate measured for Tier 1. The encoder may designate a specific section of the video content as hard to encode, e.g. if the encoder determines that the bit rate of a section is above a threshold level for a specific tier.

Then, the encoder may encode additional tiers for hard to encode section (e.g. Tier 1 sub-tiers 1.1-1.3 with CH1.5.1-CH1.8.1, CH1.5.2-CH1.8.2, CH1.5.3-CH1.8.3, and Tier 2 sub-tiers 2.1- 2.3 with CH2.5.1-CH2.8.1, CH2.5.2-CH2.8.2, CH2.5.3-CH2.8.3). Each of the additional tiers may be encoded at different bit rates, e.g. by adjusting the quantization parameter (QP) in the encoding. In this example, the encoder may encode sub-tier 1.1 through sub-tier 1.3 with bit rates represented by curves 710.1 through 710.3. The encoder may encode sub-tier 2.1 through sub-tier 2.3 similarly, e.g. with bit rates lower than tier 2. Thus, the encoder may provide the additional tiers as dense and/or gradual gradient levels of tiers, e.g. with 3 additional tiers of bit rates between Tier 1 and Tier 2 and 3 additional tiers below Tier 2). By the encoder provided additional tiers, the client device thus may see small changes in playback video quality during tier switching.

The foregoing discussion has described operation of the embodiments of the present disclosure in the context of coding servers and distribution servers. Commonly, these servers are provided as electronic devices that are populated by integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. And, of course, these components may be provided as hybrid systems that distribute functionality across dedicated hardware components and programmed general-purpose processors, as desired. Storage devices also include storage media such as electronic-, magnetic- and/or optically-based storage devices.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A method, comprising:
coding a common video sequence multiple times to yield respective instances of coded video data, each instance having video data coded according to a set of coding parameters derived from a target bit rate of a respective tier of service,
wherein for a given tier, coding is constrained to limit a maximum coding rate of the tier to be less than a target bit rate of another predetermined tier of service.

2. The method of claim 1, wherein the instances of coded video each include a plurality of chunks of coded video data.

3. The method of claim 1, wherein the instances of coded video each include a plurality of chunks of coded video data having chunk boundaries that are temporally aligned with boundaries of chunks from other instances.

4. The method of claim 3, wherein a first frame of at least one chunk is a frame that is decodable without reference to any preceding frame in coding order and all other coded frames of the respective chunk that follow the first frame in coding order have prediction references that go no earlier than the first frame.

5. The method of claim 1, further comprising storing the instances of coded video at a distribution server in association with a manifest file containing data describing the tiers.

6. The method of claim 1, further comprising, for at least one coding instance:
identifying portion(s) of the respective instance having a coding rate that exceeds the target bit rate of the instance,
coding portions of the video sequence corresponding to the identified portion(s) into a plurality of sub-tiers, each sub-tier having coding parameters that induce a respective coding rate for the identified portion(s), and
storing the coded instance and the coded sub-tiers in storage at a distribution server.

7. The method of claim 1, wherein each coded tier has a different resolution but a substantially similar aspect ratio as each other.

8. The method of claim 1, wherein at least one coded tier has a pixel aspect ratio derived from a display aspect ratio and a storage aspect ratio.

9. The method of claim 1, wherein the coding comprises:
for a first tier, estimating characteristics of the video sequence, selecting coding parameters based on the estimated characteristics and the target bit rate of the first tier and coding the video sequence according to the selected coding parameters of the first tier, and
for at least one other tier, selecting coding parameters based on the estimated characteristics and the target bit rate of the other tier, and coding the video sequence according to the selected coding parameters of the other tier.

10. The method of claim 1, wherein the coding comprises, for at least one tier:
estimating characteristics of the video sequence,
selecting coding parameters based on the estimated characteristics and a target bit rate of the respective tier,
coding the video sequence according to the selected coding parameters,
estimating a coding quality obtained from the coding, and
if the estimated coding quality is below a predetermined threshold, revising the coding parameters and repeating the coding using the revised coding parameters.

11. A distribution server, comprising:
a computer readable storage device having stored thereon a file representing a media item, the file including:
multiple coding instances of the media item, each instance having coded video data representing the media item having been coded according to a set of coding parameters derived from a target bit rate of a respective tier of service, wherein for a given tier, coding is constrained to limit a maximum coding rate of the tier to be less than a target bit rate of another predetermined tier of service, and
a manifest file containing data describing the tiers.

12. The server of claim 11, further comprising a communication system to provide data of a respective tier upon request.

13. The server of claim 11, wherein the coding instances each include a plurality of chunks of coded video data.

14. The server of claim 11, wherein the coding instances each include a plurality of chunks of coded video data having chunk boundaries that are temporally aligned with boundaries of chunks from other instances.

15. The server of claim 11, wherein a first frame of at least one chunk is a frame that is decodable without reference to any preceding frame in coding order.

16. The server of claim 11, wherein the file further comprises, for at least one instance:
a plurality of coded sub-tiers of the instance, corresponding to a portion of the respective instance having a coding rate that exceeds the target bit rate of the instance, each sub-tier coded according to coding parameters that induce a respective coding rate for the identified portion.

17. The server of claim 11, wherein each coded tier has a different resolution but a substantially similar aspect ratio as each other.

18. A coding server, comprising:
a video coder to code a common video sequence multiple times to yield respective instances of coded video data, each instance having video data coded according to a set of coding parameters derived from a target bit rate of a respective tier of service, wherein for a given tier, coding is constrained to limit a maximum coding rate of the tier to be less than a target bit rate of another predetermined tier of service, and
a storage device to store the instances of coded video data.

19. The server of claim 17, wherein the instances of coded video data each include a plurality of chunks of coded video data.

20. The server of claim 17, wherein the instances of coded video data each include a plurality of chunks of coded video data having chunk boundaries that are temporally aligned with boundaries of chunks from other instances.

21. The server of claim 17, wherein a first frame of at least one chunk is a frame that is decodable without reference to any preceding frame in coding order.

22. The server of claim 17, wherein the video coder further:
identifies a portion of the respective instance having a coding rate that exceeds the target bit rate of the instance, and
codes portions of the video sequence corresponding to the identified portion(s) into a plurality of sub-tiers, each sub-tier having coding parameters that induce a respective coding rate for the identified portion.

23. The server of claim 17, wherein each coded tier has a different resolution but a substantially similar aspect ratio as each other.

24. A computer readable storage device having stored thereon program instructions that, when executed, cause a programming device to perform a method comprising:
coding a common video sequence multiple times to yield respective instances of coded video data, each instance having video data coded according to a set of coding parameters derived from a target bit rate of a respective tier of service, wherein for a given tier, coding is constrained to limit a maximum coding rate of the tier to be less than a target bit rate of another predetermined tier of service.

25. The device of claim 24, wherein the program instructions further cause the executing device to:
identify a portion of a coding instance having a coding rate that exceeds the target bit rate of the instance, and
code portions of the video sequence corresponding to the identified portion(s) into a plurality of sub-tiers, each sub-tier having coding parameters that induce a respective coding rate for the identified portion.

26. The device of claim 24, wherein the program instructions further cause the executing device to store the instances of coded video at a distribution server in association with a manifest file containing data describing the tiers.

27. A method, comprising:
estimating characteristics of a video sequence to be coded,
coding a common video sequence multiple times to yield respective instances of coded video data, each associated with a respective tier of service, comprising for each instance:
selecting coding parameters for the respective instance based on the estimated characteristics and a target bit rate of the respective tier, wherein a maximum coding rate of at least one tier is less than a target bit rate of another predetermined tier of service and a maximum coding rate at a startup portion of a coded instance is less than a maximum coding rate of an intermediate portion of the coded instance;
coding the video sequence according to the selected coding parameters, and storing the instances of coded data at a media delivery server.

28. The method of claim 27, wherein a target bit rate of a coded instance is determined based on an estimated buffering condition of a player that is to decode the coded instance.

29. The method of claim 27, wherein select frames of the video sequence are coded as sync frames in all the coded instances.

30. The method of claim 27, wherein the coded instances are stored in individually accessible segments, each of which begins with a coded sync frame.
